(19) United States
(12) Patent Application Publication
(10) Pub. No.: US 2024/0319344 A1
(43) Pub. Date: Sep. 26, 2024

(54) LIDAR APPARATUS, METHOD FOR PROCESSING SIGNAL OF THE SAME AND NON-TRANSITORY COMPUTER-READABLE STORAGE MEDIUM STORING PROGRAM FOR PERFORMING THE METHOD

(71) Applicant: HL KLEMOVE CORP., Incheon (KR)

(72) Inventor: KiMoon KANG, Gyeonggi-do (KR)

(21) Appl. No.: 18/219,560

(22) Filed: Jul. 7, 2023

(30) Foreign Application Priority Data
Mar. 21, 2023 (KR) 10-2023-0036732

(51) Int. Cl. G01S 7/4863; G01S 7/487

(52) U.S. Cl. CPC G01S 7/4863; G01S 7/487

(57) ABSTRACT

A lidar apparatus is disclosed. The lidar apparatus according to an embodiment of the present disclosure includes an optical transmitter configured to transmit a laser light for external detection; an optical receiver configured to receive the laser light reflected from the external; and a signal processor configured to detect the laser light received by the optical receiver, wherein the signal processor may be configured to: generate information including coordinates of a plurality of points including at least one point on a rising edge, a start point of a peak, an end point of the peak, and at least one point on a falling edge of a received waveform of the laser light reflected from the external arbitrary area as pixel information about a pixel corresponding to the arbitrary area, and classify the pixel according to whether the start point of the peak and the end point of the peak are the same.

### CROSS-REFERENCE TO RELATED APPLICATION

This application claims priority to and the benefit of Korean Patent Application No. 10-2023-0036732, filed on Mar. 21, 2023, the disclosure of which is incorporated herein by reference in its entirety.

### BACKGROUND

### 1. Technical Field

The present disclosure relates to a lidar apparatus, a signal processing method of the lidar apparatus, and a non-transitory computer readable storage medium storing a program for performing the method, and more particularly, to a lidar apparatus that detects laser light transmitted to the outside and then reflected and received and processes the signal, a signal processing method of the lidar apparatus, and a non-transitory computer-readable storage medium having stored thereon a program for performing the method.

### 2. Discussion of Related Art

Lidar (Light Detection And Ranging) is a radar system that measures the distance to the outside using laser pulses. The lidar apparatus measures a distance to the outside and a shape of a measurement object, or the like by irradiating laser light to a peripheral region and measuring a time returned by being reflected from the outside. Recently, lidar apparatuses are used in various technical fields such as autonomous vehicles and mobile robots.

The lidar apparatus transmits and receives laser light in pulse form. In this case, if all the received waveforms (echo) within the field of view (FoV) are output as they are, the amount of data is enormous, making real-time transmission difficult. To solve this problem, the lidar apparatus uses information of specific points capable of expressing characteristics of a received waveform as an output. Commonly used points are the start point and end point of the peak, the start point and end point of the pulse, the point where the intensity of a pulse is medium, and the like.

As described above, when only information of specific points is used, a situation may occur in which an external target is not clearly identified. For example, there are two cases where two targets are positioned closely overlapping and a single target is positioned obliquely. In the former case, since two different received waveforms are overlapped, the two received waveforms should be distinguished for accurate detection, and in the latter case, it should be determined as a single received waveform. However, conventional lidar apparatuses are unable to perform such determination and distinguishment.

(Related Art Document) Korean Patent Laid-Open Publication No. 10-2021-0029453 entitled “LIDAR APPARATUS FOR VEHICLE”, published on Mar. 16, 2021

### SUMMARY

The present disclosure is to solve the problems of the related art described above, and the present disclosure is directed to providing a lidar apparatus, a signal processing method of a lidar apparatus, and a non-transitory computer-readable storage medium having stored thereon a program for performing the method, capable of distinguishing between a case in which two targets are closely over lapped and a case in which a single target is positioned obliquely while using only specific points in a received waveform as an output.

In addition, the present disclosure is also directed to providing a lidar apparatus, a signal processing method of a lidar apparatus, and a non-transitory computer-readable storage medium having stored thereon a program for performing the method, capable of separating an overlapped waveform when two targets are closely overlapped with each other while using only specific points in a received waveform as an output.

The objects of the present disclosure are not limited to the above-described objects, and other objects that are not mentioned will be able to be clearly understood by those skilled in the art to which the present disclosure pertains from the following description.

According to an aspect of the present disclosure, provided is a lidar apparatus, including an optical transmitter configured to transmit a laser light for external detection; an optical receiver configured to receive the laser light reflected from the external; and a signal processor configured to detect the laser light received by the optical receiver, wherein the signal processor is configured to: generate information including coordinates of a plurality of points including at least one point on a rising edge, a start point of a peak, an end point of the peak, and at least one point on a falling edge of a received waveform of the laser light reflected from the external arbitrary area as pixel information about a pixel corresponding to the arbitrary area, and classify the pixel according to whether the start point of the peak and the end point of the peak are the same.

In addition, in the lidar apparatus according to an aspect of the present disclosure, if the coordinates of the start point of the peak and the end point of the peak included in the pixel information are the same, the signal processor may classify the corresponding pixel as an additional classification unnecessary type.

In addition, in the lidar apparatus according to an aspect of the present disclosure, if the coordinates of the start point of the peak and the end point of the peak included in the pixel information are not the same, the signal processor may classify the corresponding pixel as an additional classification necessary type.

In addition, in the lidar apparatus according to an aspect of the present disclosure, when the pixel is classified as an additional classification necessary type, the signal processor may perform an additional classification on a pixel classified as an additional classification necessary type, based on pixel information of a plurality of neighboring pixels adjacent to the pixel.

In addition, in the lidar apparatus according to an aspect of the present disclosure, the signal processor may determine whether a distance between rising edges, which is a distance between a point on a rising edge included in pixel information of the pixel classified as the additional classification type and a corresponding point on a rising edge included in pixel information of each of the plurality of neighboring pixels, is within a predetermined criterion when performing the additional classification.

In addition, in the lidar apparatus according to an aspect of the present disclosure, the signal processor may determine whether a distance between falling edges, which is a distance between a point on a falling edge included in pixel information of the pixel classified as the additional classification type and a corresponding point on a falling edge included in pixel information of each of the plurality of neighboring pixels, is within a predetermined criterion when performing the additional classification.

In addition, in the lidar apparatus according to an aspect of the present disclosure, the signal processor may determine whether a sum of the number of pixels having the distance between rising edges determined within the predetermined criterion and the number of pixels having the distance between falling edges determined within the predetermined criterion among the plurality of neighboring pixels is equal to a set value.

In addition, in the lidar apparatus according to an aspect of the present disclosure, when it is determined that a sum of the number of pixels having the distance between rising edges determined within the predetermined criterion and the number of pixels having the distance between falling edges determined within the predetermined criterion among the plurality of neighboring pixels is equal to the set value, the signal processor may classify the pixel classified as the additional classification type as an overlapping type.

In addition, in the lidar apparatus according to an aspect of the present disclosure, when the pixel classified as the additional classification type is classified as an overlapping type, the signal processor may separate and calculate the over lapped received waveform from the pixel classified as the overlapping type by using the pixel information of each of the plurality of neighboring pixels.

In addition, in the lidar apparatus according to an aspect of the present disclosure, the signal processor may collect coordinates of points on the rising edge and coordinates of points on the falling edge from the plurality of neighboring pixel information, select points satisfying a first range and points satisfying a second range among the points on the rising edge, and select points satisfying a first range and points satisfying a second range among the points on the falling edge.

In addition, in the lidar apparatus according to an aspect of the present disclosure, the signal processor may calculate a first received waveform by using points satisfying the first range among the points on the rising edge and points satisfying the first range among the points on the falling edge, and calculate a second received waveform by using points satisfying the second range among the points on the rising edge and points satisfying the second range among the points on the falling edge.

In addition, in the lidar apparatus according to an aspect of the present disclosure, the first range may be selected from the top 10 to 30% based on short distance, and the second range may be selected from the top 70 to 90% based on short distance.

In addition, in the lidar apparatus according to an aspect of the present disclosure, when it is determined that a sum of the number of pixels having the distance between rising edges determined within the predetermined criterion and the number of pixels having the distance between falling edges determined within the predetermined criterion among the plurality of neighboring pixels is not equal to the set value, the signal processor may classify the pixel classified as the additional classification type as a non-overlapping type.

According to another aspect of the present disclosure, provided is a signal processing method of a lidar apparatus, including detecting, by a signal processor, laser light transmitted by an optical transmitter to outside and reflected from an external arbitrary area, and then received by an optical receiver; generating, by the signal processor, information including coordinates of a plurality of points including at least one point on a rising edge, a start point of a peak, an end point of a peak, and at least one point on a falling edge from a received waveform of the laser light as pixel information about a pixel corresponding to the arbitrary area; and classifying, by the signal processor, the pixel according to whether the start point of the peak and the end point of the peak are the same.

In addition, in the signal processing method of a lidar apparatus according to another aspect of the present disclosure, the classifying the pixel may include, if the coordinates of the start point of the peak and the end point of the peak included in the pixel information are the same, classifying, by the signal processor, the corresponding pixel as an additional classification unnecessary type.

In addition, in the signal processing method of a lidar apparatus according to another aspect of the present disclosure, the classifying the pixel may include, if the coordinates of the start point of the peak and the end point of the peak included in the pixel information are not the same, classifying, by the signal processor, the corresponding pixel as an additional classification necessary type.

In addition, in the signal processing method of a lidar apparatus according to another aspect of the present disclosure, the classifying the pixel may further include, when the pixel is classified as an additional classification necessary type, performing, by the signal processor, an additional classification on a pixel classified as an additional classification type, based on pixel information of a plurality of neighboring pixels adjacent to the pixel.

In addition, in the signal processing method of a lidar apparatus according to another aspect of the present disclosure, the performing an additional classification on a pixel may include determining, by the signal processor, whether a distance between rising edges, which is a distance between a point on a rising edge included in pixel information of the pixel classified as the additional classification type and a corresponding point on a rising edge included in pixel information of each of the plurality of neighboring pixels, is within a predetermined criterion, and calculating the number of pixels having the distance between the rising edges determined within the predetermined criterion among the plurality of neighboring pixels.

In addition, in the signal processing method of a lidar apparatus according to another aspect of the present disclosure, the performing an additional classification on a pixel may include, by the signal processor, determining whether a distance between falling edges, which is a distance between a point on a falling edge included in pixel information of the pixel classified as the additional classification type and a corresponding point on a falling edge included in pixel information of each of the plurality of neighboring pixels, is within a predetermined criterion, and calculating the number of pixels having the distance between the falling edges determined within the predetermined criterion.

In addition, in the signal processing method of a lidar apparatus according to another aspect of the present disclosure, the performing an additional classification on a pixel may further include determining, by the signal processor, whether a sum of the number of pixels having the distance between rising edges determined within the predetermined criterion and the number of pixels having the distance between falling edges determined within the predetermined criterion among the plurality of neighboring pixels is equal to a set value.

In addition, in the signal processing method of a lidar apparatus according to another aspect of the present disclosure, the performing an additional classification on a pixel may further include, when it is determined that a sum of the number of pixels having the distance between rising edges determined within the predetermined criterion and the number of pixels having the distance between falling edges determined within the predetermined criterion among the plurality of neighboring pixels is equal to the set value, classifying, by the signal processor, the pixel classified as the additional classification type as an over lapping type.

In addition, the signal processing method of a lidar apparatus according to another aspect of the present disclosure may further include, when the pixel classified as the additional classification type is classified as an overlapping type, separating and calculating, by the signal processor, the overlapped received waveform from the pixel classified as the overlapping type by using the pixel information of each of the plurality of neighboring pixels.

In addition, in the signal processing method of a lidar apparatus according to another aspect of the present disclosure, the separating and calculating two over lapped received waveforms may include, by the signal processor, collecting coordinates of points on the rising edge and coordinates of points on the falling edge from the plurality of neighboring pixel information, selecting points satisfying a first range and points satisfying a second range among the points on the rising edge, and selecting points satisfying a first range and points satisfying a second range among the points on the falling edge.

In addition, in the signal processing method of a lidar apparatus according to another aspect of the present disclosure, the separating and calculating two over lapped received waveforms may include, by the signal processor, calculating a first received waveform by using points satisfying the first range among the points on the rising edge and points satisfying the first range among the points on the falling edge, and calculating a second received waveform by using points satisfying the second range among the points on the rising edge and points satisfying the second range among the points on the falling edge.

In addition, in the signal processing method of a lidar apparatus according to another aspect of the present disclosure, the first range may be selected from the top 10 to 30% based on short distance, and the second range may be selected from the top 70 to 90% based on short distance.

In addition, in the signal processing method of a lidar apparatus according to another aspect of the present disclosure, the performing an additional classification on a pixel may further include, when it is determined that a sum of the number of pixels having the distance between rising edges determined within the predetermined criterion and the number of pixels having the distance between falling edges determined within the predetermined criterion among the plurality of neighboring pixels is not equal to the set value, classifying, by the signal processor, the pixel classified as the additional classification type as a non-overlapping type.

According to yet another aspect of the present disclosure, provided is a non-transitory computer-readable storage medium having stored thereon a program including at least one instruction for performing the signal processing method of a lidar apparatus according to another aspect of the present disclosure.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a lidar apparatus according to an embodiment of the present disclosure;

FIG. 2 is a diagram illustrating a case where a lidar apparatus according to an embodiment of the present disclosure detects two targets disposed forwardly and backwardly outside;

FIG. 3 is a diagram illustrating an example of received waveforms corresponding to area A of FIG. 2 and specific points output by a signal processor;

FIG. 4 is a diagram illustrating a case where a lidar apparatus according to an embodiment of the present disclosure detects a single target disposed obliquely;

FIG. 5 is a diagram illustrating an example of received waveforms corresponding to area B of FIG. 4 and specific points output by a signal processor;

FIG. 6 is a diagram illustrating an example of a plurality of areas selected around area A of FIG. 2;

FIG. 7 is a diagram illustrating an example of received waveforms corresponding to each area of FIG. 6 and specific points output by a signal processor;

FIG. 8 is a flowchart of a signal processing method of a lidar apparatus according to an embodiment of the present disclosure;

FIG. 9 is a detailed flowchart of a step of classifying a pixel of a signal processing method of a lidar apparatus according to an embodiment of the present disclosure;

FIG. 10 is a detailed flowchart of a step of performing an additional classification of a pixel of a signal processing method of a lidar apparatus according to an embodiment of the present disclosure; and

FIG. 11 is a detailed flowchart of a step of separating and calculating two over lapped received waveforms of a signal processing method of a lidar apparatus according to an embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

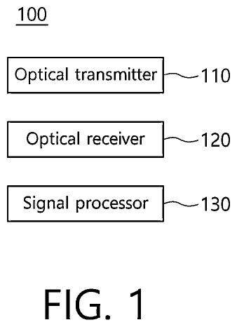

FIG. 1 is a block diagram of a lidar apparatus according to an embodiment of the present disclosure.

The lidar apparatus 100 according to an embodiment of the present disclosure may effectively distinguish between a case where two targets are positioned closely overlapping with each other and a case where a single target is positioned obliquely, while utilizing only specific points as an output in a received waveform of laser light reflected back after being transmitted to the outside.

Referring to FIG. 1, the lidar apparatus 100 according to an embodiment of the present disclosure may include an optical transmitter 110, an optical receiver 120, and a signal processor 130.

The optical transmitter 110 transmits laser light for external detection. More specifically, the optical transmitter 110 may transmit a laser pulse to the outside. The optical transmitter 110 may include a light source for generating laser light and a transmission optical system for aligning the laser light generated from the light source, and the like.

The optical receiver 120 receives the laser light reflected from the outside. The optical receiver 120 receives the laser light reflected and returned from an external target after being transmitted to the outside by the optical transmitter 110. The laser light reflected and returned from the external target may have a received waveform corresponding to the transmitted laser pulse as an echo in which the transmitted laser pulse is reflected.

The signal processor 130 detects the laser light received by the optical receiver 120. The signal processor 130 may detect and process laser light in an analog form and output the processed laser light as a signal. In this case, the output signal may be a digital signal.

The signal processor 130 may generate information including coordinates of a plurality of points including at least one point on a rising edge, a start point of a peak, an end point of a peak, and at least one point on a falling edge from a received waveform of the laser light reflected and received from the external arbitrary area as pixel information about a pixel corresponding to the arbitrary area. Here, a pixel may be defined as a basic unit on a screen in which the signal processor 130 detects and outputs the laser light reflected from the outside. In other words, each pixel may be an output unit of a lidar apparatus corresponding to an external predetermined area.

If the signal processor 130 outputs all received waveforms within a field of view (FoV) as they are, the amount of data is enormous, making real-time output difficult. In consideration of this, the signal processor 130 may generate information about a plurality of points selected on a received waveform of the laser light reflected and received from the external arbitrary area as pixel information about a pixel corresponding to the arbitrary area.

In an embodiment of the present disclosure, the signal processor 130 may classify the pixel according to whether a start point of a peak and an end point of a peak on the received waveform corresponding to the pixel information are the same. In this case, the peak may mean a portion having the greatest intensity in the received waveform.

If the coordinates of the start point of the peak and the end point of the peak included in the pixel information are the same, the signal processor 130 may classify the corresponding pixel as an additional classification unnecessary type. In general, when there is a single target vertically disposed on the outside, a received waveform of a laser pulse transmitted by the optical transmitter 110 and reflected from an arbitrary area of the target and then received by the optical receiver 120 has a sine wave shape. Therefore, the start point of the peak and the end point of the peak of the received waveform appear as the same point. In this case, even if only some feature points of the received waveform are calculated as output, the distance to the target may be accurately determined. Based on this fact, if the coordinates of the start point of the peak and the end point of the peak included in the pixel information are the same, the signal processor 130 classifies the corresponding pixel as an additional classification unnecessary type and does not perform additional classification on the corresponding pixel.

Meanwhile, if the coordinates of the start point of the peak and the end point of the peak included in the pixel information are not the same, the signal processor 130 may classify the corresponding pixel as an additional classification necessary type. If the coordinates of the start point of the peak and the end point of the peak included in the pixel information are not the same, it may be interpreted as a situation in which two or more received waveforms overlap.

As such, the situation in which two or more received waveforms over lap may mean that two or more targets are disposed in an external area corresponding to the corresponding pixel across the front and rear. Alternatively, it may mean that a single target is disposed obliquely in an external area corresponding to the corresponding pixel.

When the pixel is classified as an additional classification necessary type, the signal processor 130 may perform an additional classification on a pixel classified as an additional classification necessary type, based on pixel information of a plurality of neighboring pixels adjacent to the pixel. In more detail, when the pixel is classified as an additional classification necessary type, the signal processor 130 may additionally classify whether a pixel classified as an additional classification type indicates an area in which two or more targets are disposed across the front and rear or an area in which a single target is disposed obliquely, based on pixel information of a plurality of neighboring pixels adjacent to the pixel.

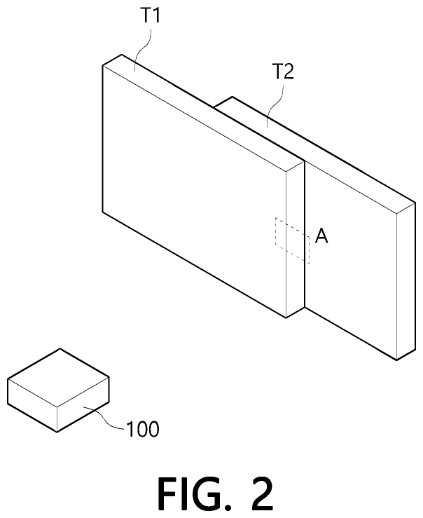

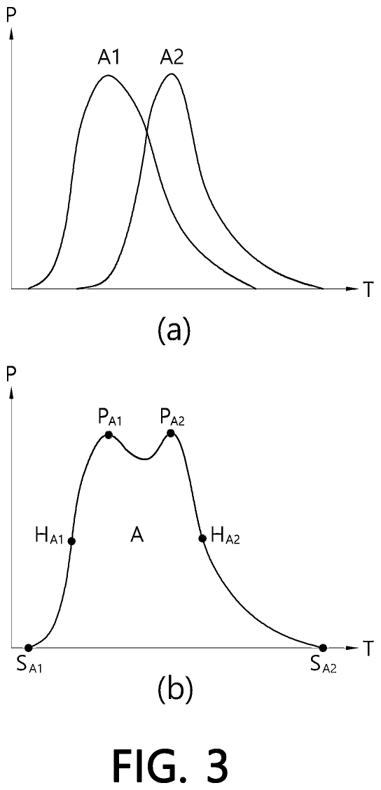

FIG. 2 is a diagram illustrating a case where a lidar apparatus according to an embodiment of the present disclosure detects two targets disposed forwardly and backwardly outside. In addition, FIG. 3 is a diagram illustrating an example of received waveforms of laser light corresponding to area A of FIG. 2 and specific points output by the signal processor.

Referring to FIG. 2, a first target T1 and a second target T2 are disposed to over lap across the front and rear. Accordingly, the laser light reflected from the area A includes a laser light reflected from the first target T1 disposed in the front and a laser light reflected from the second target T2 disposed in the rear.

Referring to (a) of FIG. 3, the received waveforms of the laser light transmitted from the optical transmitter 110 to the area A in which the first target T1 and the second target T2 are disposed across the front and rear and reflected and then received by the optical receiver 120 include two waveforms. In more detail, the received waveforms of the laser light reflected from the area A and then received by the optical receiver 120 include an A-1 received waveform (A1) transmitted from the optical transmitter 110 and reflected from the first target T1 disposed in the front and then received by the optical receiver 120, and an A-2 received waveform (A2) transmitted from the optical transmitter 110 and reflected from the second target T2 disposed in the rear and then received by the optical receiver 120.

Accordingly, as illustrated in (b) of FIG. 3, the received waveforms of the laser light transmitted from the optical transmitter 110 and reflected from the area A and then received by the optical receiver 120 are represented by two received waveforms overlapped. In more detail, the received waveforms received by the optical receiver 120 after being reflected from the area A are represented by a first overlapped waveform (A) in which the A-1 received waveform (Al) and the A-2 received waveform (A2) overlap.

As described above, the signal processor 130 generates information about a plurality of points selected on the received waveforms of the laser light reflected and received from the external arbitrary area as pixel information about a pixel corresponding to the arbitrary area in order to improve efficiency of signal processing and real-time output of a signal.

For example, as shown in (b) of FIG. 3, the signal processor 130 may generate information including coordinates of a start point (S_{A1}) of a rising edge of the first overlapped waveform (A), a point (H_{A1}) having an intermediate intensity on the rising edge, a start point (P_{A1}) of a peak, an end point (P_{A2}) of the peak, a point (H_{A2}) having an intermediate intensity on a falling edge, and an end point (S_{A2}) of the falling edge, and the like, as pixel information about a pixel corresponding to the area A.

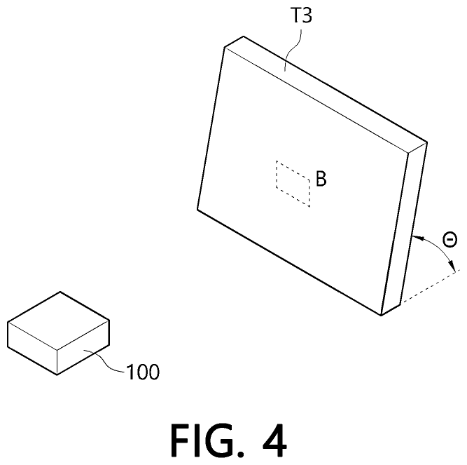

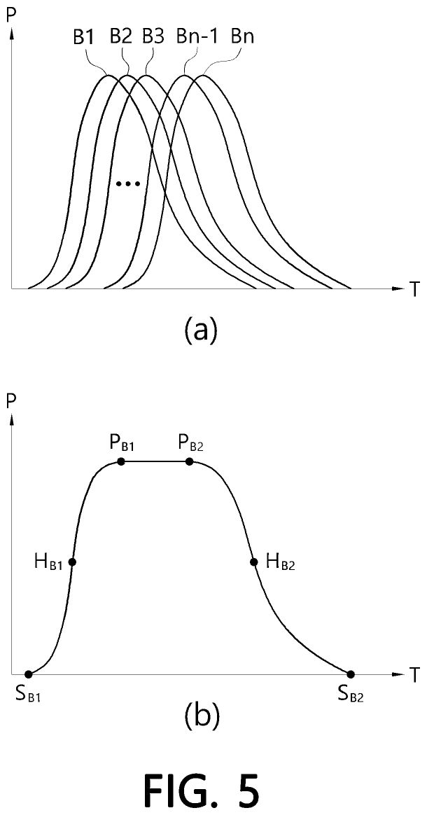

FIG. 4 is a diagram illustrating a case where a lidar apparatus according to an embodiment of the present disclosure detects a single target disposed obliquely. In addition, FIG. 5 is a diagram illustrating an example of received waveforms of laser light corresponding to area B of FIG. 4 and specific points output by the signal processor.

Referring to FIG. 4, a single third target T3 is disposed obliquely outside the lidar apparatus 100 to be detected. More specifically, the third target T3 is disposed to form a predetermined angle θ that is greater than 0 and less than 90 degrees with respect to the ground.

Accordingly, the laser light transmitted from the optical transmitter 110 and reflected from the area B includes laser light reflected from a lower end of the slope, laser light reflected from a middle of the slope, and laser light reflected from an upper end of the slope. In other words, the laser light reflected from the area B and received by the optical receiver 120 may include a plurality of received waveforms.

Referring to (a) of FIG. 5, when the single third target T3 is disposed obliquely outside, the received waveforms transmitted from the optical transmitter 110 and reflected from the area B and received by the optical receiver 120 include a plurality of waveforms. Specifically, the received waveforms reflected from the area B and then received by the optical receiver 120 include a B-1 received waveform (B1) received by the optical receiver 120 after being reflected from a lower end of the slope of the third target T3, a B-n received waveform (Bn) received by the optical receiver 120 after being reflected from an upper end of the slope of the third target T3, and a plurality of received waveforms (B2, B3, . . . , Bn-1) received by the optical receiver 120 after being reflected between the lower end of the slope and the upper end of the slope of the third target T3.

Accordingly, as illustrated in (b) of FIG. 5, the received waveforms of the laser light transmitted from the optical transmitter 110 and reflected from the area B and then received by the optical receiver 120 are represented by a plurality of received waveforms overlapped. In more detail, the received waveforms received by the optical receiver 120 after being reflected from the area B are represented by a second overlapped waveform (B) in which the B-1 received waveform (B1) to the B-n received waveform (Bn) overlap.

For example, as shown in (b) of FIG. 5, the signal processor 130 may generate information including coordinates of a start point (S_{B1}) of a rising edge of the second overlapped waveform (B), a point (H_{B1}) having an intermediate intensity on the rising edge, a start point (P_{B1}) of a peak, an end point (P_{B2}) of the peak, a point (H_{B2}) having an intermediate intensity on a falling edge, and an end point (S_{B2}) of the falling edge, and the like, as pixel information about a pixel corresponding to the area B.

Referring to FIGS. 3 and 5, a pattern of coordinates of a start point (S_{A1}) of a rising edge of the first overlapped waveform (A), a point (H_{A1}) having an intermediate intensity on the rising edge, a start point (P_{A1}) of a peak, an end point (P_{A2}) of the peak, a point (H_{A2}) having an intermediate intensity on a falling edge, and an end point (S_{A2}) of the falling edge generated by the signal processor 130 as pixel information about a pixel corresponding to the area A, is similar to a pattern of coordinates of a start point (S_{B1}) of a rising edge of the second over lapped waveform (B), a point (H_{B1}) having an intermediate intensity on the rising edge, a start point (P_{B1}) of a peak, an end point (P_{B2}) of the peak, a point (H_{B2}) having an intermediate intensity on a falling edge, and an end point (S_{B2}) of the falling edge generated by the signal processor 130 as pixel information about a pixel corresponding to the area B.

In other words, the shape of the first overlapped waveform (A) corresponding to the area A cannot be accurately identified only with the pixel information generated by the signal processor 130 for the area A. This is because a change in intensity (waveform) between a start point (P_{A1}) of a peak and an end point (P_{A2}) of the peak on the first overlapped waveform (A) cannot be accurately estimated.

In another aspect, the shape of the second overlapped waveform (B) corresponding to the area B cannot be accurately identified only with the pixel information generated by the signal processor 130 for the area B. This is because a change in intensity (waveform) between a start point (P_{B1}) of a peak and an end point (P_{B2}) of the peak on the second overlapped waveform (B) cannot be accurately estimated.

As such, when the signal processor 130 generates only information about a plurality of points limitedly selected on a received waveform of laser light reflected from a target disposed in an external arbitrary area as pixel information about a pixel corresponding to the arbitrary area, it may be difficult to accurately identify a received waveform reflected and received from the arbitrary area.

Specifically, when the pixel information is limitedly generated as described above, it may be substantially very difficult to distinguish a case in which two targets are disposed across the front and rear, as shown in FIG. 2 and a case in which a single target is disposed obliquely as shown in FIG. 4 with only pixel information of a pixel corresponding to a specific area.

To solve this problem, when pixel information is generated from overlapped waveforms in which two or more received waveforms are overlapped, the signal processor 130 of the lidar apparatus 100 according to an embodiment of the present disclosure classifies the corresponding pixel as an additional classification necessary type. In addition, the signal processor 130 performs additional classification on the corresponding pixel.

According to an embodiment of the present disclosure, a pixel corresponding to the area A and a pixel corresponding to the area B may be classified as a type requiring additional classification, respectively. In the present disclosure, the signal processor 130 distinguishes a case in which two targets are disposed across the front and rear, as shown in FIG. 2 and a case in which a single target is disposed obliquely as shown in FIG. 4 through the execution of the additional classification.

Further, when it is determined that two targets are disposed across the front and rear in an external area corresponding to a pixel to be subjected to the additional classification, the lidar apparatus 100 according to the present disclosure may separate a received waveform reflected from the target disposed in the front and a received waveform reflected from the target disposed in the rear.

In more detail, when a pixel corresponding to an external arbitrary area is classified as an additional classification necessary type, the signal processor 130 may perform an additional classification on the pixel classified as the additional classification type, based on pixel information of a plurality of neighboring pixels adjacent to the corresponding pixel.

When performing the additional classification, the signal processor 130 may utilize a distance between rising edges, which is a distance between a point on a rising edge included in the pixel information of the pixel classified as the additional classification necessary type and a corresponding point on the rising edge included in the pixel information of each of a plurality of neighboring pixels adjacent to the pixel classified as the additional classification type. In more detail, the signal processor 130 may determine whether the distance between rising edges is within a predetermined criterion.

In addition, when performing the additional classification, the signal processor 130 may utilize a distance between falling edges, which is a distance between a point on a falling edge included in the pixel information of the pixel classified as the additional classification necessary type and a corresponding point on the falling edge included in the pixel information of each of a plurality of neighboring pixels adjacent to the pixel classified as the additional classification type. In more detail, the signal processor 130 may determine whether the distance between falling edges is within a predetermined criterion.

In addition, the signal processor 130 may determine the number of pixels having the distance between rising edges determined within the predetermined criterion and the number of pixels having the distance between falling edges determined within the predetermined criterion among the plurality of neighboring pixels, respectively, and determine whether a sum of the number of pixels having the distance between rising edges determined within the predetermined criterion and the number of pixels having the distance between falling edges determined within the predetermined criterion is equal to a set value.

When it is determined that a sum of the number of pixels having the distance between rising edges determined within the predetermined criterion and the number of pixels having the distance between falling edges determined within the predetermined criterion among the plurality of neighboring pixels is equal to the set value, the signal processor 130 may classify the pixel classified as the additional classification type as an overlapping type.

Here, the overlapping type corresponds to a state in which two targets are disposed in front and rear as shown in FIG. 2. That is, it can be considered that two targets are disposed in front and rear in an external area corresponding to the pixel additionally classified as the overlapping type.

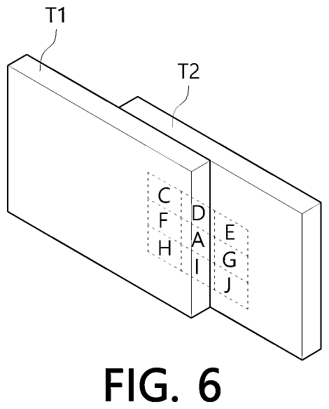

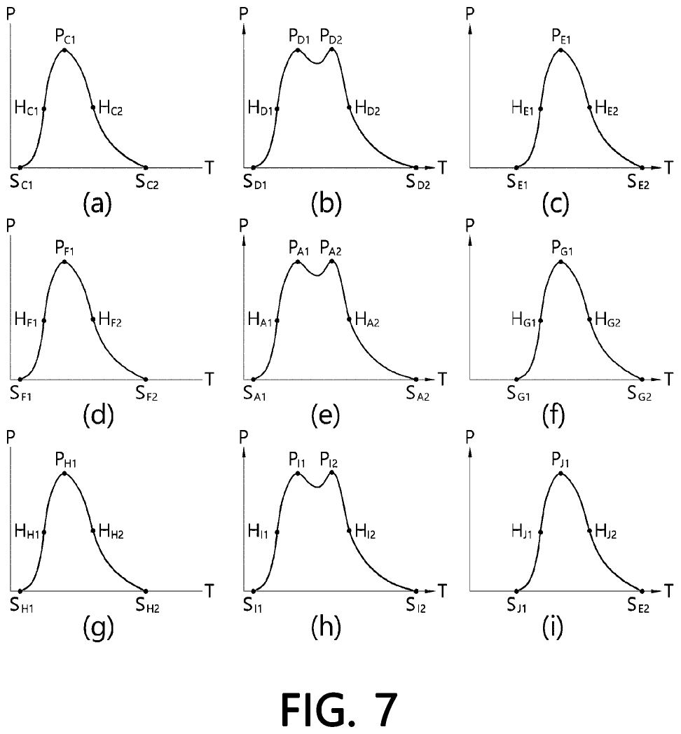

Hereinafter, a process of performing the additional classification on the pixel classified as the additional classification type by the signal processor 130 of the lidar apparatus 100 according to an embodiment of the present disclosure will be described in detail with reference to FIGS. 6 and 7.

FIG. 6 is a diagram illustrating an example of a plurality of areas selected around area A of FIG. 2. The area A of FIG. 6 is the same as the area A of FIG. 2. According to an embodiment of the present disclosure, a pixel corresponding to the area A may be classified as a pixel requiring additional classification. In this case, the signal processor 130 may utilize information on neighboring pixels of the pixel requiring additional classification.

Referring to FIG. 6, an area C, an area D, an area E, an area F, an area G, an area H, an area I, and an area J exist around the area A. In other words, the area C, the area D, the area E, the area F, the area G, the area H, the area I, and the area J are disposed to surround the area A.

In an embodiment of the present disclosure, the signal processor 130 may utilize pixel information of the area C, pixel information of the area D, pixel information of the area E, pixel information of the area F, pixel information of the area G, pixel information of the area H, pixel information of the area I, and pixel information of the area J, which are disposed to surround the area A, in order to additionally classify the pixel corresponding to the area A.

FIG. 7 is a diagram illustrating an example of received waveforms corresponding to each area of FIG. 6 and specific points output by a signal processor. In FIG. 7, T may mean time, and P may mean intensity.

Since laser light reflected from a target at a relatively close distance from the lidar apparatus 100 is received to the lidar apparatus 100 prior to laser light reflected from a target at a relatively far distance from the lidar apparatus 100, the value of time T is small.

Referring to FIGS. 6 and 7, only the first target T1 is detected in the area C. Accordingly, the start point and the end point of the peak of the received waveform of the laser light reflected from the first target T1 in the area C may have the same shape.

As pixel information corresponding to the area C, the signal processor 130 may generate coordinates of a start point S_{C1} of a rising edge, a point H_{C1} having an intermediate intensity on the rising edge, a start point P_{C1} of a peak (in this case, it appears the same as an end point of the peak), a point H_{C2} having an intermediate intensity on a falling edge, and an end point S_{C2} of the falling edge, and the like on a received waveform of laser light reflected from the first target T1 in the area C.

In addition, like in the area C, only the first target T1 is detected in the area F and the area H. Accordingly, the start point and the end point of the peak of the received waveform of the laser light reflected from the first target T1 in the area F and the area H may have the same shape.

In this regard, as pixel information corresponding to the area F, the signal processor 130 may generate coordinates of a start point S_{F1} of a rising edge, a point H_{F1} having an intermediate intensity on the rising edge, a start point P_{F1} of a peak (in this case, it appears the same as an end point of the peak), a point H_{F2} having an intermediate intensity on a falling edge, and an end point S_{F2} of the falling edge, and the like on a received waveform of laser light reflected from the first target T1 in the area F.

In addition, as pixel information corresponding to the area H, the signal processor 130 may generate coordinates of a start point S_{H1} of a rising edge, a point H_{H1} having an intermediate intensity on the rising edge, a start point P_{H1} of a peak (in this case, it appears the same as an end point of the peak), a point H_{H2} having an intermediate intensity on a falling edge, and an end point S_{H2} of the falling edge, and the like on a received waveform of laser light reflected from the first target T1 in the area H.

Meanwhile, in the area D and the area I, the first target T1 and the second target T2 are disposed in the front and rear, respectively, like in the area A. Accordingly, the received waveforms of the laser light reflected from the area D and the area I have a shape in which the received waveform reflected from the first target T1 and the received waveform reflected from the second target T2 are over lapped.

In this regard, as pixel information corresponding to the area D, the signal processor 130 may generate coordinates of a start point S_{D1} of a rising edge, a point H_{D1} having an intermediate intensity on the rising edge, a start point P_{D1} of a peak, an end point P_{D2} of the peak, a point H_{D2} having an intermediate intensity on a falling edge, and an end point S_{D2} of the falling edge, and the like on a received waveform in which the laser light reflected from the first target T1 of the area D and the laser light reflected from the second target T2 of the area D are overlapped.

In addition, as pixel information corresponding to the area I, the signal processor 130 may generate coordinates of a start point S_{I1} of a rising edge, a point H_{I1} having an intermediate intensity on the rising edge, a start point P_{I1} of a peak, an end point P_{I2} of the peak, a point H_{I2} having an intermediate intensity on a falling edge, and an end point S_{I2} of the falling edge, and the like on a received waveform in which the laser light reflected from the first target T1 of the area I and the laser light reflected from the second target T2 of the area I are overlapped.

On the other hand, only the second target T2 is disposed in the area E, the area G, and the area J. Therefore, only the second target T2 is detected in the area E, the area G, and the area J. Accordingly, the start point and the end point of the peak of the received waveform of the laser light reflected from the second target T2 in the area E, the area G and the area J may have the same shape.

In this regard, as pixel information corresponding to the area E, the signal processor 130 may generate coordinates of a start point S_{E1} of a rising edge, a point H_{E1} having an intermediate intensity on the rising edge, a start point P_{E1} of a peak (in this case, it appears the same as an end point of the peak), a point H_{E2} having an intermediate intensity on a falling edge, and an end point S_{E2} of the falling edge, and the like on a received waveform of laser light reflected from the second target T2 in the area E.

In addition, as pixel information corresponding to the area G, the signal processor 130 may generate coordinates of a start point S_{G1} of a rising edge, a point H_{G1} having an intermediate intensity on the rising edge, a start point P_{G1} of a peak (in this case, it appears the same as an end point of the peak), a point H_{G2} having an intermediate intensity on a falling edge, and an end point S_{G2} of the falling edge, and the like on a received waveform of laser light reflected from the second target T2 in the area G.

In addition, as pixel information corresponding to the area J, the signal processor 130 may generate coordinates of a start point S_{J1} of a rising edge, a point H_{J1} having an intermediate intensity on the rising edge, a start point P_{J1} of a peak (in this case, it appears the same as an end point of the peak), a point H_{J2} having an intermediate intensity on a falling edge, and an end point S_{J2} of the falling edge, and the like on a received waveform of laser light reflected from the second target T2 in the area J.

Next, the signal processor 130 compares the pixel information of the pixel classified as the additional classification type with the pixel information of the pixels disposed around the pixel classified as the additional classification type.

For example, the signal processor 130 may compare the distances of points on the rising edge of the pixel information of the pixel classified as the additional classification type with corresponding points on the rising edge of the pixels disposed around the pixel classified as the additional classification type. In addition, the signal processor 130 may compare the distances of points on the falling edge of the pixel information of the pixel classified as the additional classification type with corresponding points on the falling edge of the pixels disposed around the pixel classified as the additional classification type.

In more detail, the signal processor 130 may determine whether a distance between rising edges, which is a distance between an arbitrary one point on a rising edge included in pixel information of an additional classification type pixel and a corresponding point on a rising edge included in pixel information of each of the plurality of neighboring pixels, is within a predetermined criterion.

Referring to the examples shown in FIGS. 6 and 7, a start point S_{A1} of a rising edge included in pixel information of a pixel corresponding to the area A which is an additional classification type is related to a received waveform reflected from the first target T1 located relatively short distance from the lidar apparatus 100.

Meanwhile, among areas disposed around the area A which is an additional classification type, a start point S_{C1} of a rising edge included in pixel information corresponding to the area C, a start point S_{D1} of a rising edge included in pixel information corresponding to the area D, a start point S_{F1} of a rising edge included in pixel information corresponding to the area F, a start point S_{H1} of a rising edge included in pixel information corresponding to the area H, and a start point S_{I1} of a rising edge included in pixel information corresponding to the area I are also related to a received waveform reflected from the first target T1 located relatively short distance from the lidar apparatus 100.

Therefore, a start point S_{C1} of a rising edge included in pixel information corresponding to the area C, a start point S_{D1} of a rising edge included in pixel information corresponding to the area D, a start point S_{F1} of a rising edge included in pixel information corresponding to the area F, a start point S_{H1} of a rising edge included in pixel information corresponding to the area H, and a start point S_{I1} of a rising edge included in pixel information corresponding to the area I are located relatively short distance from a start point S_{A1} of a rising edge included in pixel information of a pixel corresponding to the area A.

In addition, among areas disposed around the area A which is an additional classification type, a start point S_{E1} of a rising edge included in pixel information corresponding to the area E, a start point S_{G1} of a rising edge included in pixel information corresponding to the area G, and a start point S_{J1} of a rising edge included in pixel information corresponding to the area J are related to a received waveform reflected from the second target T2 located relatively far distance from the lidar apparatus 100.

Therefore, a start point S_{E1} of a rising edge included in pixel information corresponding to the area E, a start point S_{G1} of a rising edge included in pixel information corresponding to the area G, and a start point S_{J1} of a rising edge included in pixel information corresponding to the area J are located relatively far distance from a start point S_{A1} of a rising edge included in pixel information of a pixel corresponding to the area A.

In this case, if a predetermined criterion is set appropriately, when pixel information corresponding to the area C, the area D, the area F, the area H, and the area I is compared with pixel information corresponding to the area A, the distances between the rising edges may each be within the predetermined criterion.

In addition, when pixel information corresponding to the area E, the area G, and the area J is compared with pixel information corresponding to the area A, the distances between the rising edges may be each larger than the predetermined criterion.

In the above case, the signal processor 130 may calculate the number N_{R} of pixels where the distance between the rising edges is within a predetermined criterion among the eight pixels corresponding to the eight neighboring areas disposed around the pixel corresponding to the area A as five.

The signal processor 130 may determine whether a distance between rising edges, which is a distance between any one point on a falling edge included in pixel information of a pixel classified as an additional classification necessary type and a corresponding point on a falling edge included in pixel information of each of pixels disposed around the pixel classified as the additional classification type, is within a predetermined criterion.

Referring to the examples shown in FIGS. 6 and 7, an end point S_{A2} of a falling edge included in pixel information of a pixel corresponding to the area A which is an additional classification necessary type is related to a received waveform reflected from the second target T2 located relatively far distance from the lidar apparatus 100.

Meanwhile, among areas disposed around the area A which is an additional classification necessary type, an end point S_{C2} of a falling edge included in pixel information corresponding to the area C, an end point S_{F2} of a falling edge included in pixel information corresponding to the area F, and an end point S_{H2} of a falling edge included in pixel information corresponding to the area H are related to a received waveform reflected from the first target T1 located relatively short distance from the lidar apparatus 100.

Therefore, an end point S_{C2} of a falling edge included in pixel information corresponding to the area C, an end point S_{F2} of a falling edge included in pixel information corresponding to the area F, and an end point S_{H2} of a falling edge included in pixel information corresponding to the area H are located relatively far distance from an end point S_{A2} of a falling edge included in pixel information of a pixel corresponding to the area A.

In addition, among areas disposed around the area A which is an additional classification necessary type, an end point S_{D2} of a falling edge included in pixel information corresponding to the area D, an end point S_{E2} of a falling edge included in pixel information corresponding to the area E, an end point S_{G2} of a falling edge included in pixel information corresponding to the area G, an end point S_{I2} of a falling edge included in pixel information corresponding to the area I, and an end point S_{J2} of a falling edge included in pixel information corresponding to the area J are related to a received waveform reflected from the second target T2 located relatively far distance from the lidar apparatus 100.

Therefore, an end point S_{D2} of a falling edge included in pixel information corresponding to the area D, an end point S_{E2} of a falling edge included in pixel information corresponding to the area E, an end point S_{G2} of a falling edge included in pixel information corresponding to the area G, an end point S_{I2} of a falling edge included in pixel information corresponding to the area I, and an end point S_{J2} of a falling edge included in pixel information corresponding to the area J are located relatively short distance from an end point S_{A2} of a falling edge included in pixel information of a pixel corresponding to the area A.

In this case, if a predetermined criterion is set appropriately, when pixel information corresponding to the area C, the area F, and the area H is compared with pixel information corresponding to the area A, the distances between the falling edges may be each larger than the predetermined criterion.

In addition, when pixel information corresponding to the area D, the area E, the area G, the area I, and the area J is compared with pixel information corresponding to the area A, the distances between the falling edges may each be within the predetermined criterion.

In the above case, the signal processor 130 may calculate the number N_{F} of pixels where the distance between the falling edges is within a predetermined criterion among the eight pixels corresponding to the eight neighboring areas disposed around the pixel corresponding to the area A as five.

Next, the signal processor 130 may calculate a sum of the number N_{R} of pixels having the distance between the rising edges determined within the predetermined criterion and the number N_{F} of pixels having the distance between falling edges determined within the predetermined criterion among the plurality of neighboring pixels, and compare the calculated sum with a preset value.

In addition, when it is determined that a sum of the number N_{R} of pixels having the distance between rising edges determined within the predetermined criterion and the number N_{F} of pixels having the distance between falling edges determined within the predetermined criterion is equal to the set value, the signal processor 130 may classify the pixel classified as the additional classification type as an overlapping type.

Referring to the example shown in FIGS. 6 and 7, the set value may be 8. Accordingly, when it is determined that a sum of the number N_{R} of pixels having the distance between rising edges determined within the predetermined criterion and the number N_{F} of pixels having the distance between falling edges determined within the predetermined criterion is 10, the signal processor 130 may classify the pixel corresponding to the area A as an overlapping type.

On the other hand, when it is determined that a sum of the number N_{R} of pixels having the distance between rising edges determined within the predetermined criterion and the number N_{F} of pixels having the distance between falling edges determined within the predetermined criterion among the plurality of neighboring pixels is not equal to the set value, the signal processor 130 may classify the pixel classified as the additional classification type as a non-over lapping type.

For example, when neighboring areas are set similarly to those shown in FIG. 6 based on the area B shown in FIG. 4 and the above procedure is performed, there is no tendency as shown in FIG. 7. This is because the distance between the targets disposed in the respective neighboring areas or the distance to the targets within one neighboring area is continuously changed.

Based on the above fact, when the sum of the number of pixels having the distance between rising edges determined within the predetermined criterion and the number of pixels having the distance between falling edges determined within the predetermined criterion among the plurality of neighboring pixels is not equal to the set value, the signal processor 130 may classify the pixel classified as the additional classification type as a non-overlapping type.

In the above, the comparison between the start points of the rising edges in relation to the distance between the rising edges and the comparison between the end points of the falling edges in relation to the distance between the falling edges are only examples for explanation.

For the comparison of the distance between the rising edges, another point on the rising edge may be used, or a plurality of points on the rising edge may be used. In addition, for the comparison of the distance between the falling edges, another point on the falling edge may be used, or a plurality of points on the falling edge may be used. In this case, in relation to the distance between the rising edges, a point on the rising edge may be used as a meaning including a start point of a peak. In addition, in relation to the distance between the falling edges, a point on the falling edge may be used as a meaning including an end point of a peak.

In addition, the number of neighboring pixels adjacent to the pixel corresponding to the area classified as the additional classification type is also not particularly limited. The number of neighboring pixels of the pixel corresponding to the area classified as the additional classification type may vary depending on conditions. In addition, the set value to be compared with the sum of the number N_{R} of pixels having the distance between the rising edges determined within a predetermined criterion and the number N_{F} of pixels having the distance between the falling edges determined within a predetermined reference may also vary.

In an embodiment of the present disclosure, when the pixel classified as the additional classification type is classified as the overlapping type, the signal processor 130 may separate and calculate the overlapped received waveform from the pixel classified as the overlapping type by using the pixel information of each of the plurality of neighboring pixels. As described above, the signal processor 130 may classify the pixel corresponding to the area A of FIG. 6 as the over lapping type. Additionally, the signal processor 130 may separate the first received waveform A1 and the second received waveform A2 from the overlapped received waveform A corresponding to the area A.

First, the signal processor 130 may collect coordinates of points on the rising edge and coordinates of points on the falling edge from the information of the plurality of neighboring pixels. In addition, the signal processor 130 may select points satisfying the first range and points satisfying the second range among the collected points on the rising edge, and may select points satisfying the first range and points satisfying the second range among the collected points on the falling edge.

Here, a point on the rising edge may be used as a meaning including a start point of a peak. In addition, a point on the falling edge may be used as a meaning including an end point of a peak.

For example, the first range may be selected from the top 10 to 30% based on short distance, and the second range may be selected from the top 70 to 90% based on short distance. In more detail, the first range may be selected as the top 20% based on short distance, and the second range may be selected as the top 80% based on short distance.

Referring to FIGS. 3, 6 and 7, the signal processor 130 may collect coordinates of a start point of a rising edge, a point having an intermediate intensity on the rising edge, a start point of a peak, an end point of the peak, a point having an intermediate intensity on a falling edge, and an end point of the falling edge, respectively, from the information of the pixels corresponding to the area A and the eight areas around the area A.

In addition, the signal processor 130 may separate the collected coordinates of the points into the coordinates on the rising edge and the coordinates on the falling edge, respectively. In other words, the signal processor 130 may store a set of coordinates on the rising edge and a set of coordinates on the falling edge, respectively.

As such, after separating the points on the rising edge and the points on the falling edge, the signal processor 130 may select the points on the rising edge and select the points on the falling edge, according to a predetermined criterion.

In more detail, the signal processor 130 may calculate the first received waveform by using points satisfying the first range (e.g., top 20% based on short distance) among points on the rising edge and points satisfying the first range among points on the falling edge. Specifically, the signal processor 130 may estimate the first received waveform by combining points satisfying the first range (e.g., top 20% based on short distance) among points on the rising edge and points satisfying the first range among points on the falling edge. Accordingly, the first received waveform A1, as shown in FIG. 3 may be separated and calculated.

Meanwhile, the signal processor 130 may calculate the second received waveform by using points satisfying the second range (e.g., top 80% based on short distance) among points on the rising edge and points satisfying the second range among points on the falling edge. Specifically, the signal processor 130 may estimate the second received waveform by combining points satisfying the second range (e.g., top 80% based on short distance) among points on the rising edge and points satisfying the second range among points on the falling edge. Accordingly, the second received waveform A2, as shown in FIG. 3 may be separated and calculated.

Hereinafter, a signal processing method of a lidar apparatus according to an embodiment of the present disclosure will be described. The signal processing method of a lidar apparatus according to an embodiment of the present disclosure may be performed through the lidar apparatus 100 according to an embodiment of the present disclosure.

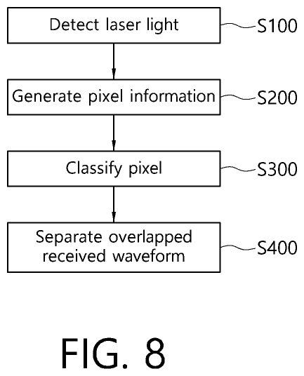

FIG. 8 is a flowchart of a signal processing method of a lidar apparatus according to an embodiment of the present disclosure. Referring to FIG. 8, the signal processing method of a lidar apparatus according to an embodiment of the present disclosure may be performed as follows.

First, a signal processor 130 detects laser light transmitted to the outside by an optical transmitter 110 and reflected from an arbitrary area outside and then received by an optical receiver 120 at step S100. In this case, the signal processor 130 may detect and process laser light in an analog form and output the processed laser light as a signal.

Nest, the signal processor 130 may generate information including coordinates of a plurality of points including at least one point on a rising edge, a start point of a peak, an end point of a peak, and at least one point on a falling edge from a received waveform of the laser light as pixel information about a pixel corresponding to the arbitrary area at step S200. In other words, the signal processor 130 may generate information about a plurality of points selected on a received waveform of the laser light reflected and received from the external arbitrary area as pixel information about a pixel corresponding to the arbitrary area.

Next, the signal processor 130 classifies the pixel according to whether the start point of the peak and the end point of the peak of the received waveform of the laser light are the same at step S300.

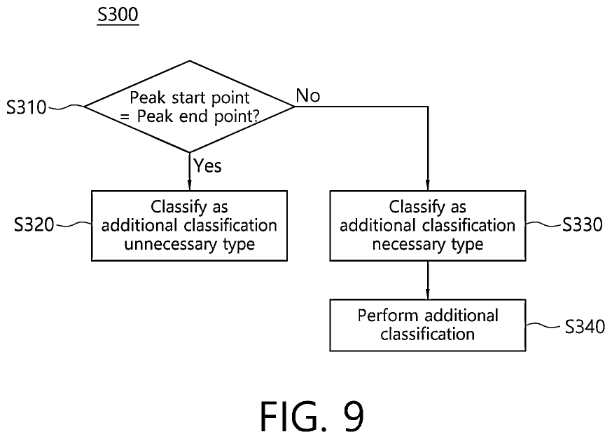

FIG. 9 is a detailed flowchart of a step of classifying a pixel of a signal processing method of a lidar apparatus according to an embodiment of the present disclosure. Referring to FIG. 9, the pixel classification may be performed as follows.

First, the signal processor 130 may determine whether the coordinates of the start point of the peak and the end point of the peak included in the pixel information are the same at step S310. As described above, whether the coordinates of the start point of the peak and the end point of the peak included in the specific pixel information are the same may be a criterion for determining whether the received waveform is reflected and received from a single target vertically disposed outside.

Nest, if the coordinates of the start point of the peak and the end point of the peak included in the pixel information are the same, the signal processor 130 classifies the corresponding pixel as an additional classification unnecessary type at step S320. When there is a single target vertically disposed on the outside, a received waveform of a laser pulse transmitted by the optical transmitter 110 and reflected from an arbitrary area of the target and then received by the optical receiver 120 has a sine wave shape. Therefore, the start point of the peak and the end point of the peak of the received waveform appear as the same point. In this case, even if only some feature points of the received waveform are calculated as output, the distance to the target may be accurately determined.

Meanwhile, if the coordinates of the start point of the peak and the end point of the peak included in the pixel information are not the same, the signal processor 130 classifies the corresponding pixel as an additional classification necessary type at step S330. If the coordinates of the start point of the peak and the end point of the peak included in the pixel information are not the same, it may be understood as a situation in which two or more received waveforms overlap. In this case, it may be estimated that two or more targets are disposed across the front and rear or a single target is disposed obliquely in an external area corresponding to the corresponding pixel.

Next, when the pixel is classified as an additional classification necessary type, the signal processor 130 performs an additional classification on the pixel classified as an additional classification type based on pixel information of a plurality of neighboring pixels adjacent to the pixel classified as an additional classification type at step S340.

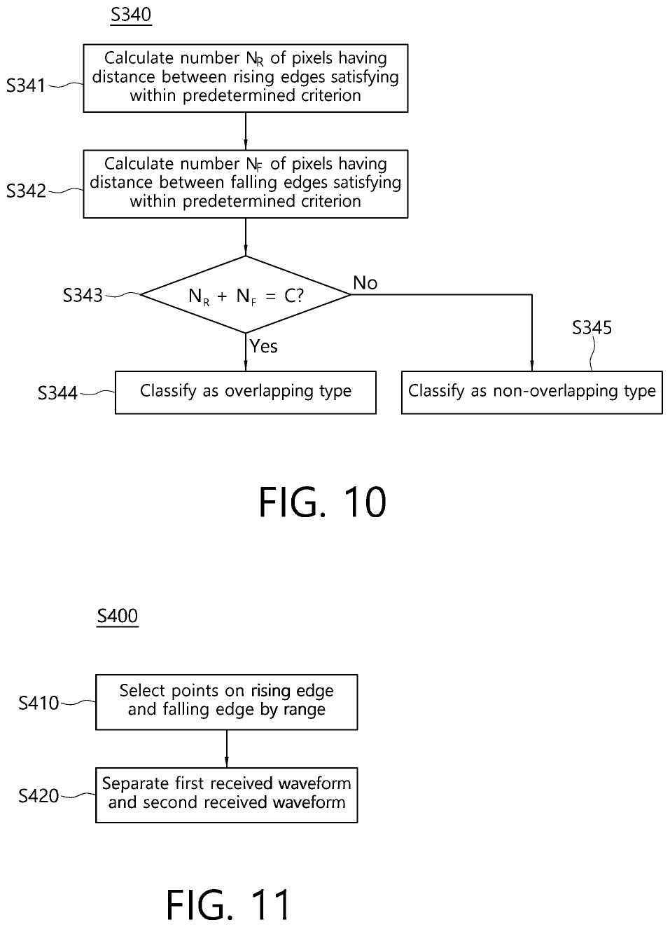

FIG. 10 is a detailed flowchart of a step of performing an additional classification of a pixel of a signal processing method of a lidar apparatus according to an embodiment of the present disclosure. Referring to FIG. 10, the additional classification on the pixel may be performed as follows.

First, the signal processor 130 determines whether a distance between rising edges, which is a distance between a point on a rising edge included in pixel information of the pixel classified as the additional classification type and a corresponding point on a rising edge included in pixel information of each of a plurality of neighboring pixels adjacent to the corresponding pixel, is within a predetermined criterion, and calculates the number N_{R} of pixels having the distance between the rising edges determined within the predetermined criterion among the plurality of neighboring pixels at step S341.

Next, the signal processor 130 determines whether a distance between falling edges, which is a distance between a point on a falling edge included in pixel information of the pixel classified as the additional classification type and a corresponding point on a falling edge included in pixel information of each of a plurality of neighboring pixels adjacent to the corresponding pixel, is within a predetermined criterion, and calculates the number N_{F} of pixels having the distance between the falling edges determined within the predetermined criterion among the plurality of neighboring pixels at step S342.

Meanwhile, the step of calculating the number of pixels having the distance between the rising edges determined within the predetermined criterion and the step of calculating the number of pixels having the distance between the falling edges determined within the predetermined criterion among the plurality of neighboring pixels may be changed in order or may be performed at the same time.

In addition, in relation to the distance between the rising edges, a point on the rising edge may be used as a meaning including a start point of a peak. In addition, in relation to the distance between the falling edges, a point on the falling edge may be used as a meaning including an end point of a peak.

Next, the signal processor 130 determines whether a sum of the number N_{R} of pixels having the distance between the rising edges determined within the predetermined criterion and the number N_{F} of pixels having the distance between falling edges determined within the predetermined criterion among the plurality of neighboring pixels is equal to a set value C at step S343.

Next, when it is determined that a sum of the number of pixels having the distance between rising edges determined within the predetermined criterion and the number of pixels having the distance between falling edges determined within the predetermined criterion among the plurality of neighboring pixels is equal to the set value, the signal processor 130 classifies the pixel classified as the additional classification type as an overlapping type at step S344.

Meanwhile, when it is determined that a sum of the number of pixels having the distance between rising edges determined within the predetermined criterion and the number of pixels having the distance between falling edges determined within the predetermined criterion among the plurality of neighboring pixels is not equal to the set value, the signal processor 130 classifies the pixel classified as the additional classification type as a non-overlapping type at step S345.

The selection of the pixel requiring additional classification and the plurality of neighboring pixels adjacent to the corresponding pixel, the information of the plurality of neighboring pixels, the distance between rising edges and the predetermined criterion, the distance between falling edges and the predetermined criterion, the set value C, and the like are the same as those described with reference to FIGS. 6 and 7. Therefore, detailed descriptions thereof will be omitted.

Meanwhile, in the signal processing method of the lidar apparatus according to an embodiment of the present disclosure, when the pixel classified as the additional classification type is classified as the overlapping type, the signal processor 130 separates and calculates the overlapped received waveform from the pixel classified as the overlapping type by using the pixel information of each of the plurality of neighboring pixels at step S400.

FIG. 11 is a detailed flowchart of a step of separating and calculating two over lapped received waveforms of a signal processing method of a lidar apparatus according to an embodiment of the present disclosure. Referring to FIG. 11, the separation and calculation of the two received waveforms may be performed as follows.

First, the signal processor 130 collects coordinates of points on the rising edge and coordinates of points on the falling edge from the plurality of neighboring pixel information, selects points satisfying a first range and points satisfying a second range among the points on the rising edge, and selects points satisfying a first range and points satisfying a second range among the points on the falling edge at step S410.

The signal processor 130 may separate the collected coordinates of the points into the coordinates on the rising edge and the coordinates on the falling edge, respectively. In other words, the signal processor 130 may store a set of coordinates on the rising edge and a set of coordinates on the falling edge, respectively.

Here, a point on the rising edge may be used as a meaning including a start point of a peak. In addition, a point on the falling edge may be used as a meaning including an end point of a peak.

For example, the first range may be selected from the top 10 to 30% based on short distance, and the second range may be selected from the top 70 to 90% based on short distance. In more detail, the first range may be selected as the top 20% based on short distance, and the second range may be selected as the top 80% based on short distance.

Next, the signal processor 130 calculates a first received waveform by using points satisfying the first range among the points on the rising edge and points satisfying the first range among the points on the falling edge, and calculates a second received waveform by using points satisfying the second range among the points on the rising edge and points satisfying the second range among the points on the falling edge at step S420.

For example, the signal processor 130 may calculate the first received waveform by using points satisfying the first range (e.g., top 20% based on short distance) among points on the rising edge and points satisfying the first range among points on the falling edge. In more detail, the signal processor 130 may estimate the first received waveform by combining points satisfying the first range (e.g., top 20% based on short distance) among points on the rising edge and points satisfying the first range among points on the falling edge.

In addition, the signal processor 130 may calculate the second received waveform by using points satisfying the second range (e.g., top 80% based on short distance) among points on the rising edge and points satisfying the second range among points on the falling edge. In more detail, the signal processor 130 may estimate the second received waveform by combining points satisfying the second range (e.g., top 80% based on short distance) among points on the rising edge and points satisfying the second range among points on the falling edge.

Meanwhile, the present disclosure also provides a non-transitory computer-readable storage medium having stored thereon a program including at least one instruction for performing a signal processing method of a lidar apparatus according to an embodiment of the present disclosure. In this case, the instructions may include not only machine code generated by a compiler but also higher level language code executable by a computer.

The recording medium may include a hardware device configured to store and perform program instructions such as a hard disk, a magnetic medium such as a floppy disk and a magnetic tape, an optical medium such as a compact disk read only memory (CD-ROM) and a digital video disk (DVD), a magneto-optical medium such as a floptical disk, a read-only memory (ROM), a random access memory (RAM), a flash memory, and the like.

According to the present disclosure, a case where two targets are closely overlapped with each other and a case where a single target is obliquely located may be distinguished by using information of a pixel corresponding to an external specific area and a main neighboring pixel.

In addition, according to the present disclosure, the overlapped received waveform included in a pixel corresponding to an area where two targets are closely overlapped with each other may be efficiently separated.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A lidar apparatus, comprising:
an optical transmitter configured to transmit a laser light for external detection;
an optical receiver configured to receive the laser light reflected from the external; and
a signal processor configured to detect the laser light received by the optical receiver,
wherein the signal processor is configured to:
generate information including coordinates of a plurality of points including at least one point on a rising edge, a start point of a peak, an end point of the peak, and at least one point on a falling edge of a received waveform of the laser light reflected from the external arbitrary area as pixel information about a pixel corresponding to the arbitrary area, and
classify the pixel according to whether the start point of the peak and the end point of the peak are the same.

2. The lidar apparatus of claim 1, wherein if the coordinates of the start point of the peak and the end point of the peak included in the pixel information are not the same, the signal processor classifies the corresponding pixel as an additional classification necessary type.

3. The lidar apparatus of claim 2, wherein when the pixel is classified as an additional classification necessary type, the signal processor performs an additional classification on a pixel classified as an additional classification necessary type, based on pixel information of a plurality of neighboring pixels adjacent to the pixel.

4. The lidar apparatus of claim 3, wherein the signal processor determines whether a distance between rising edges, which is a distance between a point on a rising edge included in pixel information of the pixel classified as the additional classification type and a corresponding point on a rising edge included in pixel information of each of the plurality of neighboring pixels, is within a predetermined criterion when performing the additional classification.

5. The lidar apparatus of claim 4, wherein the signal processor determines whether a distance between falling edges, which is a distance between a point on a falling edge included in pixel information of the pixel classified as the additional classification type and a corresponding point on a falling edge included in pixel information of each of the plurality of neighboring pixels, is within a predetermined criterion when performing the additional classification.

6. The lidar apparatus of claim 5, wherein when it is determined that a sum of the number of pixels having the distance between rising edges determined within the predetermined criterion and the number of pixels having the distance between falling edges determined within the predetermined criterion among the plurality of neighboring pixels is equal to a set value, the signal processor classifies the pixel classified as the additional classification type as an overlapping type.

7. The lidar apparatus of claim 6, wherein when the pixel classified as the additional classification type is classified as an overlapping type, the signal processor separates and calculates the overlapped received waveform from the pixel classified as the overlapping type by using the pixel information of each of the plurality of neighboring pixels.

8. The lidar apparatus of claim 7, wherein the signal processor collects coordinates of points on the rising edge and coordinates of points on the falling edge from the pixel information of each of the plurality of neighboring pixels, selects points satisfying a first range and points satisfying a second range among the points on the rising edge, and selects points satisfying a first range and points satisfying a second range among the points on the falling edge.

9. The lidar apparatus of claim 8, wherein the signal processor calculates a first received waveform by using points satisfying the first range among the points on the rising edge and points satisfying the first range among the points on the falling edge, and calculates a second received waveform by using points satisfying the second range among the points on the rising edge and points satisfying the second range among the points on the falling edge.

10. A signal processing method of a lidar apparatus, comprising:
detecting, by a signal processor, laser light transmitted by an optical transmitter to outside and reflected from an external arbitrary area, and then received by an optical receiver;
generating, by the signal processor, information including coordinates of a plurality of points including at least one point on a rising edge, a start point of a peak, an end point of a peak, and at least one point on a falling edge from a received waveform of the laser light as pixel information about a pixel corresponding to the arbitrary area; and
classifying, by the signal processor, the pixel according to whether the start point of the peak and the end point of the peak are the same.

11. The signal processing method of a lidar apparatus of claim 10, wherein the classifying the pixel comprises, if the coordinates of the start point of the peak and the end point of the peak included in the pixel information are not the same, classifying, by the signal processor, the corresponding pixel as an additional classification necessary type.

12. The signal processing method of a lidar apparatus of claim 11, wherein the classifying the pixel further comprises, when the pixel is classified as an additional classification necessary type, performing, by the signal processor, an additional classification on a pixel classified as an additional classification type, based on pixel information of a plurality of neighboring pixels adjacent to the pixel.

13. The signal processing method of a lidar apparatus of claim 12, wherein the performing an additional classification on a pixel comprises determining, by the signal processor, whether a distance between rising edges, which is a distance between a point on a rising edge included in pixel information of the pixel classified as the additional classification type and a corresponding point on a rising edge included in pixel information of each of the plurality of neighboring pixels, is within a predetermined criterion, and calculating the number of pixels having the distance between the rising edges determined within the predetermined criterion among the plurality of neighboring pixels.

14. The signal processing method of a lidar apparatus of claim 13, wherein the performing an additional classification on a pixel comprises, by the signal processor, determining whether a distance between falling edges, which is a distance between a point on a falling edge included in pixel information of the pixel classified as the additional classification type and a corresponding point on a falling edge included in pixel information of each of the plurality of neighboring pixels, is within a predetermined criterion, and calculating the number of pixels having the distance between the falling edges determined within the predetermined criterion.

15. The signal processing method of a lidar apparatus of claim 14, wherein the performing an additional classification on a pixel further comprises determining, by the signal processor, whether a sum of the number of pixels having the distance between rising edges determined within the predetermined criterion and the number of pixels having the distance between falling edges determined within the predetermined criterion among the plurality of neighboring pixels is equal to a set value.

16. The signal processing method of a lidar apparatus of claim 15, wherein the performing an additional classification on a pixel further comprises, when it is determined that a sum of the number of pixels having the distance between rising edges determined within the predetermined criterion and the number of pixels having the distance between falling edges determined within the predetermined criterion among the plurality of neighboring pixels is equal to the set value, classifying, by the signal processor, the pixel classified as the additional classification type as an overlapping type.

17. The signal processing method of a lidar apparatus of claim 16, further comprising, when the pixel classified as the additional classification type is classified as an overlapping type, separating and calculating, by the signal processor, the overlapped received waveform from the pixel classified as the over lapping type by using the pixel information of each of the plurality of neighboring pixels.

18. The signal processing method of a lidar apparatus of claim 17, wherein the separating and calculating overlapped received waveforms comprises, by the signal processor, collecting coordinates of points on the rising edge and coordinates of points on the falling edge from the plurality of neighboring pixel information, selecting points satisfying a first range and points satisfying a second range among the points on the rising edge, and selecting points satisfying a first range and points satisfying a second range among the points on the falling edge.

19. The signal processing method of a lidar apparatus of claim 18, wherein the separating and calculating two overlapped received waveforms comprises, by the signal processor, calculating a first received waveform by using points satisfying the first range among the points on the rising edge and points satisfying the first range among the points on the falling edge, and calculating a second received waveform by using points satisfying the second range among the points on the rising edge and points satisfying the second range among the points on the falling edge.

20. A non-transitory computer-readable storage medium having stored thereon a program including at least one instruction for performing the signal processing method of a lidar apparatus of claim 10.
